(19) United States
(12) Patent Application Publication
(10) Pub. No.: US 2014/0052899 A1
(43) Pub. Date: Feb. 20, 2014

(54) MEMORY ADDRESS TRANSLATION METHOD FOR FLASH STORAGE SYSTEM

(71) Applicant: Yen Chih Nan, Hsinchu City (TW)

(72) Inventor: Yen Chih Nan, Hsinchu City (TW)

(21) Appl. No.: 13/589,124

(22) Filed: Aug. 18, 2012

(51) Int. Cl. G06F 12/02

(52) U.S. Cl. 711/103; 711/E12.008

(57) ABSTRACT

A memory address translation method for flash storage system is disclosed. There are two level mapping tables to reduce overhead of mapping table management. In level-one mapping table, each entry contains two kinds of information, which one is the validation of this entry, called Valid Mark and the other is the location of level-two mapping. The level-one mapping table is always located on RAM, and never saved into flash memory. In level-two mapping table, each entry contains two kinds of information, which one is the validation of this entry and the other is the physical location of data in flash memory. The physical addresses of both data and level-two mapping table are dynamically determined. Level-two mapping table is loaded to RAM when it is needed to reference, and is saved into flash memory periodically if the content is updated.

### FIELD OF THE INVENTION

The present invention provides a memory address translation method for flash storage system, especially for a dynamic logical to physical memory mapping method and wear-leveling method to extend flash memory life cycle.

### BACKGROUND OF THE INVENTION

Flash memory is a popular storage media option in recent year. Advantage is less power, less weight, less cost compare to hard disk. And its major weak point is the life cycle.

Logical to physical memory mapping method can different with various basic mapping units. The basic mapping units can be byte, word, dword, qword, sector, page and block. The last two kinds of mapping unit, page and block, are commonly used in flash memory because of the physical characteristic of flash operation. Advantage of choosing basic mapping unit as block is the smaller size of mapping table. On the other hands, the disadvantage of choosing basic mapping unit as page is huge size of mapping table.

However, the mapping table size for both two kinds of mapping unit increases with growth of flash memory density. That means, a multiple level mapping is obviously needed especially for mobile application. Mobile system is always cost sensitive with size of cache memory. The larger cache memory implies lesser overhead for mapping table management.

### SUMMARY OF THE INVENTION

An objective of this invention is providing a memory address translation method for flash storage system, which is capable of saving all of the mapping tables in flash memory, which level-one mapping table is always resided in cache memory that can save time for table exchange between cache memory and flash memory and by aid of level-one table, a level-two table can be loaded to cache memory for further logical to physical translation.

To achieve above objectives, a memory address translation method for flash storage system, which the flash memory storage system has a RAM including a level-one mapping and a flash memory including a level-two mapping table, the steps comprising:
saving at least one first entry with two information in the level-one mapping table storing in the RAM, one information of the first entry is a validation of the first entry, and the other information of the first entry is a location of level-two mapping; and
saving at least one second entry with two information in the level-two mapping table storing in the flash memory, one information of the second entry is a validation of the second entry, and the other information of the second entry is a physical location of data in flash memory.

Wherein, the level-one mapping is dynamic rebuilt at the storage system powered on a initialization stage.

Wherein, the physical location information is different between each second entry in the level-two mapping table.

Wherein, a size of the data that level-two mapping table maps to is a byte, a word, a double word, a sector, a physical page, multiple physical pages, a physical block, or multiple physical blocks.

Wherein, the physical addresses of both the data and the level-two mapping table are dynamically determined.

Wherein, the level-two mapping table is loaded to the RAM when it is needed to reference, and is saved into the flash memory periodically if a content of the level-two mapping table is updated.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 shows a flash memory storage system diagram.

FIG. 2 shows a two level logical to physical mapping table architecture.

### DESCRIPTION OF THE PREFERRED EMBODIMENT

Referring now to the drawings where like characteristics and features among the various figures are denoted by like reference characters.

Lift time is an essential weak point of flash memory cell. In order to overcome this physical limitation, a dynamic logical to physical address mapping has developed. With various kind of application for flash memory, the dynamic logical to physical address mapping (is as short term as mapping table) is designed with different way. A low performance required application, mapping table designed target is to enhance life time of memory cell. In this application, the algorithm of mapping table could be more complex. On the other hand, a high performance required application, designed target is to reduce overhead of mapping table management. Of course, RAM size of storage system can be different.

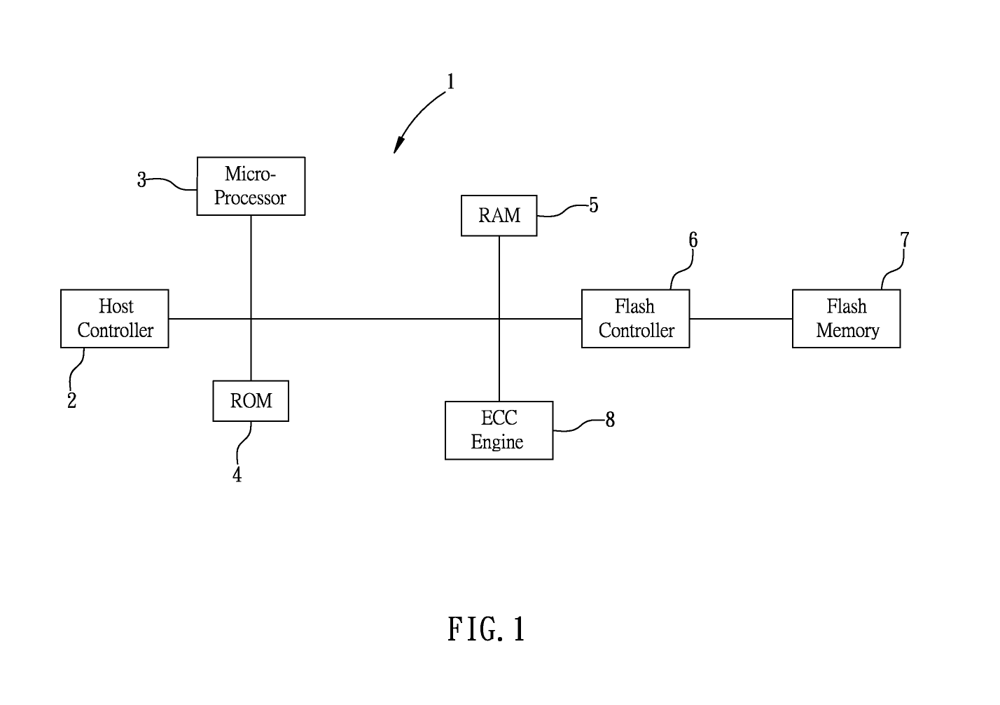

FIG. 1 shows a block diagram of a flash memory storage system. Micro-processor 3 is a general purpose operating unit. ROM 4 saves FW code to control whole storage system 1. RAM 5 is used as data ram for managing FW variable, mapping table, data hash, and etc. Flash Controller 6 communicates with flash memory 7. ECC Engine 8 is designed to enhance data integrity of flash data. Host Controller 2 is used to handle various Host interface protocols.

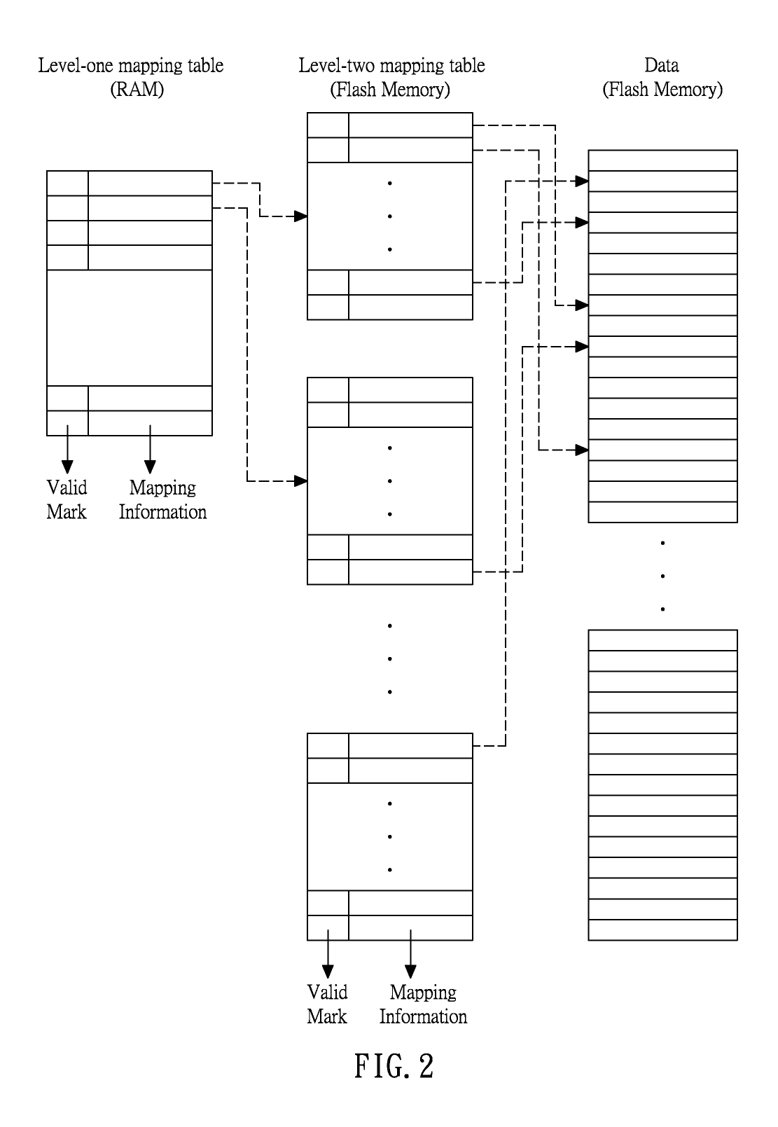

FIG. 2 shows a dynamic logical to physical address mapping table with two level mapping. The goal of this two level mapping tables is to reduce overhead of mapping table management. There are lots of entries in level-one mapping table. Each entry contains two kinds of information. One is the validation of this entry, called Valid Mark. The other is the location of level-two mapping. Level-one mapping table is always located on RAM, and never saved into flash memory. The level-one mapping is dynamic rebuilt at a storage system powered on initialization stage. The level-two mapping table also contains lots of entries. Each entry contains two kinds of information. One is the validation of this entry, and the other is the physical location of data in flash memory. The physical location information is different between each entry in level-two mapping table. The data size that level-two mapping table maps to could be a byte, a word, a double word, a sector, a physical page, multiple physical pages, a physical block, or multiple physical blocks. The physical addresses of both data and level-two mapping table are dynamically determined. Level-two mapping table is loaded to RAM when it is needed to reference, and is saved into flash memory periodically if the content is updated.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A memory address translation method for flash storage system, which the flash memory storage system has a RAM including a level-one mapping and a flash memory including a level-two mapping table, the steps comprising:
saving at least one first entry with two information in the level-one mapping table storing in the RAM, one information of the first entry is a validation of the first entry, and the other information of the first entry is a location of level-two mapping; and
saving at least one second entry with two information in the level-two mapping table storing in the flash memory, one information of the second entry is a validation of the second entry, and the other information of the second entry is a physical location of data in flash memory.

2. The method as claimed in claim 1, wherein the level-one mapping is dynamic rebuilt at the storage system powered on a initialization stage.

3. The method as claimed in claim 1, wherein the physical location information is different between each second entry in the level-two mapping table.

4. The method as claimed in claim 1, wherein a size of the data that level-two mapping table maps to is a byte, a word, a double word, a sector, a physical page, multiple physical pages, a physical block, or multiple physical blocks.

5. The method as claimed in claim 1, wherein the physical addresses of both the data and the level-two mapping table are dynamically determined.

6. The method as claimed in claim 1, wherein the level-two mapping table is loaded to the RAM when it is needed to reference, and is saved into the flash memory periodically if a content of the level-two mapping table is updated.
